(19) United States
(12) Patent Application Publication
(10) Pub. No.: US 2021/0162841 A1
(43) Pub. Date: Jun. 3, 2021

(54) VEHICLE DOOR MODULE

(71) Applicant: INTEVA PRODUCTS LLC, Troy, MI (US)

(72) Inventors: Brian H. Staser, Oxford, MI (US); Gabriel Hazon, Ouzouer-sur-loire (FR)

(21) Appl. No.: 16/772,880

(22) PCT Filed: Dec. 14, 2018
(86) PCT No.: PCT/US2018/065625

§ 371 Date: Jun. 15, 2020

(30) Foreign Application Priority Data
Dec. 15, 2017 (EP) 17306793.5

(51) Int. Cl. B60J 5/04; B60R 13/02

(52) U.S. Cl. CPC B60J 5/0416; B62D 29/043; B60R 13/0243

(57) ABSTRACT

A vehicle door module comprises a perimeter portion and areas circumscribed by the perimeter portion, wherein the circumscribed areas comprise a polyolefin and have a thickness of 1 to less than 1.8 millimeters (mm) and the perimeter portion comprises a polyolefin and a reinforcing filler.

### BACKGROUND

Vehicle door modules are part of an integrated door assembly. The vehicle door module has attachment provisions for a number of components such as a window regulator, speaker and wire harness. The vehicle door module provides sufficient structural strength to support these components and to support their function.

Previously vehicle door modules were formed from metal, plastic, or a combination thereof. As there is an increasing need and desire to reduce overall vehicle weight, there is an increasing need and desire to reduce the weight of all vehicle components while maintaining the same functionality. Accordingly, there is a need and desire for a vehicle door module with decreased weight compared to previous vehicle door modules.

### BRIEF DESCRIPTION

Disclosed herein is a vehicle door module comprising a perimeter portion and areas circumscribed by the perimeter portion, wherein the circumscribed areas comprise a polyolefin and have a thickness of 1 to less than 1.8 millimeters (mm) and the perimeter portion comprises a polyolefin and a reinforcing filler.

Also disclosed herein is a method of making a vehicle door module comprising injection molding a polyolefin and a reinforcing filler to form a perimeter portion and areas circumscribed by the perimeter portion, wherein injection molding comprises using sequential valve gating, and the circumscribed areas have a thickness of 1 to less than 1.8 millimeters.

### BRIEF DESCRIPTION OF THE DRAWINGS

The following descriptions should not be considered limiting in any way. With reference to the accompanying drawings, like elements are numbered alike:

FIG. 1 depicts a vehicle door module having areas circumscribed by a perimeter portion.

FIG. 2 depicts the obverse side of the vehicle door module depicted in FIG. 1.

FIG. 3 depicts a cross section of a portion of the vehicle door module depicted in FIGS. 1 and 2.

FIG. 4 depicts the location of a cross section of the vehicle door module.

FIG. 5 depicts a cross section of a portion of the vehicle door module depicted in FIG. 4.

### DETAILED DESCRIPTION

A detailed description of one or more embodiments of the disclosed apparatus and method are presented herein by way of exemplification and not limitation with reference to the Figures.

The vehicle door module described herein has areas circumscribed by a perimeter portion. The circumscribed areas have a reduced thickness compared to conventional vehicle door modules and offer a reduction in weight and cost compared to current commercially available vehicle door modules. The perimeter portion provides the majority of the required structure for the door module.

The circumscribed areas comprise a polyolefin. Exemplary polyolefins include polyethylene, polypropylene, polyethylene copolymer, polypropylene copolymer, or combinations thereof. The polyolefin may have a viscosity greater than or equal to 130 grams per 10 minutes as determined by ASTM D 1238.

The circumscribed areas may further comprise a reinforcing filler. Exemplary reinforcing fillers include glass fiber, carbon fiber, aramid fiber, or a combination thereof. The circumscribed areas may comprise 10 to 60, or, 25 to 40 weight percent of the reinforcing filler, based on the total weight of the circumscribed areas.

The circumscribed areas may have a thickness of 1 to less than 1.8 millimeters (mm), or, more specifically, 1.1 to 1.3 mm The thickness of the circumscribed areas may vary somewhat across the circumscribed area depending upon structural need but is less than 1.8 mm at all areas.

The circumscribed areas may further comprise features such as locations for bayonet connections and the like which have thicknesses exceeding 1.8 mm. In some embodiments the features have a thickness less than 3.0 mm

The perimeter portion comprises a polyolefin and a reinforcing filler. Exemplary polyolefins include polyethylene, polypropylene, polyethylene copolymer, polypropylene copolymer, or combinations thereof. The polyolefin and reinforcing filler combination may have a viscosity of 2 to 6 grams per 10 minutes as determined by ASTM D1238. In some embodiments the polyolefin employed in the perimeter portion has a viscosity which is greater than or equal to the viscosity of the polyolefin employed in the circumscribed areas. In some embodiments the polyolefin employed in the perimeter portion is polypropylene. In some embodiments the polyolefin employed in the perimeter portion and the circumscribed areas is polypropylene.

The perimeter portion further comprises a reinforcing filler. Exemplary reinforcing fillers include glass fiber, carbon fiber, aramid fiber, or a combination thereof. The perimeter portion comprises 10 to 60, or, 25 to 40 weight percent of the reinforcing filler, based on the total weight of the perimeter portion. The glass fiber and carbon fiber may be discontinuous chopped fiber and have an average length of 0.5 to 5 mm

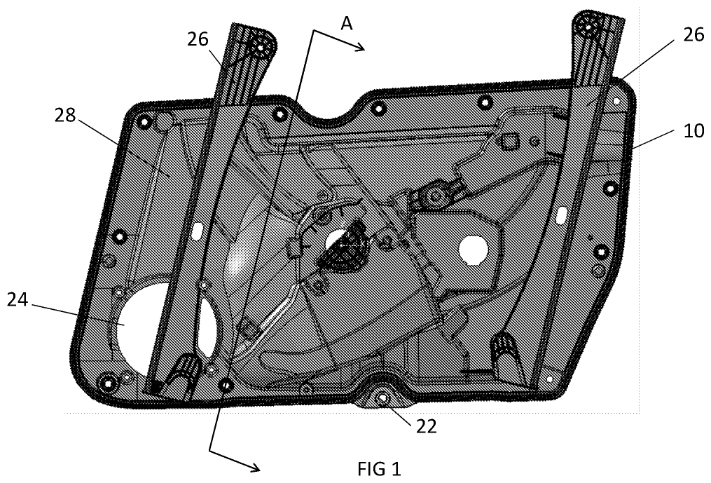

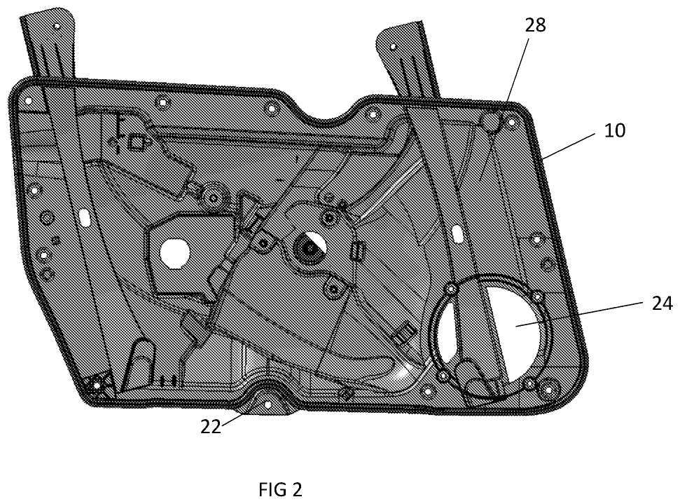

The perimeter portion has a thickness greater than or equal to the circumscribed areas. The thickness of the perimeter portion is less than 1.8 mm “Thickness” as used herein is the dimension determined by a cross section of the door module shown in FIGS. 1 and 2. Otherwise stated it is the distance between the two sides shown in FIG. 1 and FIG. 2.

In some embodiments the circumscribed areas comprise polypropylene and glass fiber and the perimeter portion comprises polypropylene and glass fiber. In some embodiments the circumscribed areas and the perimeter portion comprise the same material.

The circumscribed areas and the perimeter portion may further comprise a pigment, dye or other additive such as a flame retardant.

FIG. 1 shows a vehicle door module having perimeter portion 10 and circumscribed areas 28. The door module has through holes, 22, for attachment of other portions of the door assembly, and a location, 24, for an audio speaker. FIG. 1 shows a window regulator, 26, with integrated rails but it is also contemplated that any window regulator system could be used. The circumscribed area 28 is located within the boundaries of the perimeter portion 10. FIG. 2 shows the obverse side of the vehicle door module shown in FIG. 1.

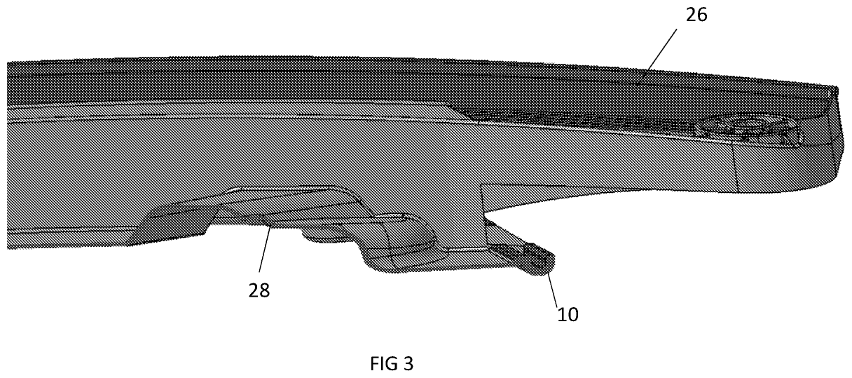

FIG. 3 shows a portion of cross section A of FIG. 1. FIG. 3 shows the thickness of circumscribed area 28 and perimeter portion 10. The location of window regulator 26 is also noted.

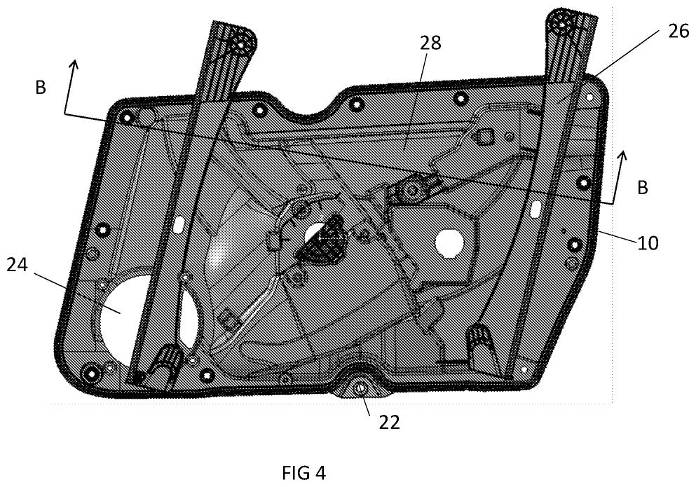

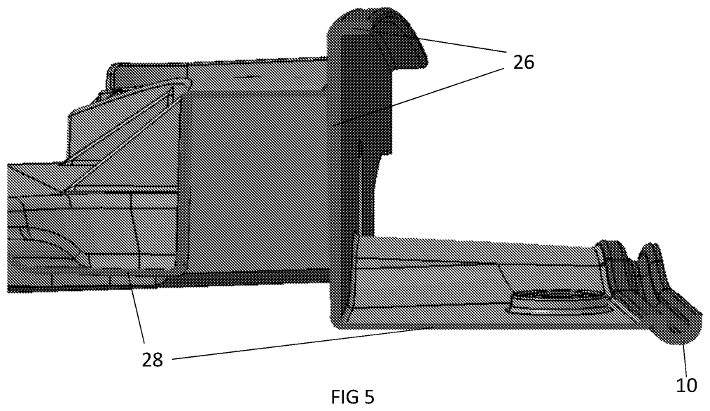

FIG. 4 is the same vehicle door module as FIG. 1 with a different cross section (B) noted. FIG. 5 is a portion of cross section B showing the thicknesses of circumscribed area 28 and perimeter portion 10. The location of window regulator 26 is noted.

The vehicle door module may be made by first forming the perimeter portion and then overmolding the circumscribed areas. The perimeter portion and the subsequent overmolding can occur in the same tool or separate tools as needed. If necessary, the perimeter portion may be surfaced treated or coated with an adhesive to promote adhesion.

It is also contemplated that a circumscribed areas can be formed in the same tool as is used for molding the perimeter portion. Through the use of sequential valve gating and multiple drops a mixture of polyolefin and reinforcing filler can be injection molded to form the perimeter portion and the circumscribed areas in a single process and in a single mold.

In a third approach the vehicle door module can be made using injection compression molding.

In any of the foregoing methods the molding temperatures, times and pressures will be determined by the materials employed and can be determined by a man of skill in the art.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims. cm 1. A vehicle door module comprising a perimeter portion and areas circumscribed by the perimeter portion, wherein the circumscribed areas comprise a polyolefin and have a thickness of 1 to less than 1.8 millimeters (mm) and the perimeter portion comprises a polyolefin and a reinforcing filler.

2. The vehicle door module of claim 1, wherein the perimeter portion comprises polypropylene and glass fiber.

3. The vehicle door module of claim 2, wherein the glass fiber is present in an amount of 25 to 40 weight percent, based on the total weight of the perimeter portion.

4. The vehicle door module of claim 1, any of the preceding claims, wherein the circumscribed areas further comprise a reinforcing filler.

5. The vehicle door module of claim 4, wherein the reinforcing filler in the circumscribed areas comprises glass fiber.

6. The vehicle door module of claim 5, wherein the circumscribed areas comprise glass fiber in an amount of 25 to 40 weight percent, based on the total weight of the circumscribed area.

7. The vehicle door module of claim 1, any of the preceding claims wherein the polyolefin of the perimeter portion has a viscosity greater than or equal to the polyolefin of the circumscribed areas.

8. The vehicle door module of claim 1, any of the preceding claims wherein the polyolefin of the circumscribed areas has a viscosity greater than or equal to 130 grams per 10 minutes as determined by ASTM D 1238.

9. The vehicle door module of claim 1, any of the preceding claims, wherein the perimeter portion and the circumscribed areas both comprise polypropylene.

10. The vehicle door module of claim 1, any of the preceding claims, wherein the perimeter portion has a thickness that is greater than or equal to the thickness of the circumscribed area.

11. A method of making a vehicle door module comprising injection molding a polyolefin and a reinforcing filler to form a perimeter portion and areas circumscribed by the perimeter portion, wherein injection molding comprises using sequential valve gating, and the circumscribed areas have a thickness of 1 to less than 1.8 millimeters.

12. The method of claim 11, wherein the polyolefin comprises polypropylene and the reinforcing filler comprises glass fiber.

13. The method of claim 11, wherein the reinforcing filler is present in an amount of 25 to 40 weight percent, based on the total weight of the perimeter portion and the circumscribed areas.

14. The method of any of claims 11, wherein the polyolefin and glass fiber combined has a viscosity of 2 to 6 grams per 10 minutes as determined by ASTM D 1238.

15. The method of claim 11, wherein the perimeter portion has a thickness that is greater than or equal to the thickness of the circumscribed area.

16. A method of making a vehicle door module comprising overmolding a perimeter portion with a polyolefin to form circumscribed areas wherein the circumscribed areas have a thickness of 1 to less than 1.8 millimeters (mm) and the perimeter portion comprises a polyolefin and a reinforcing filler.
